(19) United States
(12) Patent Application Publication
(10) Pub. No.: US 2026/0094741 A1
(43) Pub. Date: Apr. 2, 2026

(54) MANUFACTURING METHOD OF ELECTRONIC COMPONENT UNIT AND ELECTRONIC COMPONENT UNIT

(71) Applicant: YAZAKI CORPORATION, Tokyo (JP)

(72) Inventors: Shingo NOMOTO, Makinohara-shi (JP); Keisuke YAMAUCHI, Makinohara-shi (JP); Taisuke FUKATSU, Makinohara-shi (JP); Kotaro AKINO, Makinohara-shi (JP)

(73) Assignee: YAZAKI CORPORATION, Tokyo (JP)

(21) Appl. No.: 19/341,177

(22) Filed: Sep. 26, 2025

(30) Foreign Application Priority Data
Sep. 27, 2024 (JP) 2024-168704

(51) Int. Cl. H01C 1/02; H01C 7/00; H01C 17/00

(52) U.S. Cl. CPC H01C 1/02; H01C 7/008; H01C 17/00

(57) ABSTRACT

A method for producing an electronic component unit includes a first step of producing a base member and a second step of selecting one of a connector-type housing and a case-type housing and assembling the selected housing to the base member. In a case of selecting the connector-type housing, the connector-type housing is integrally and additionally molded with the base member so as to fill an engaging portion of the base member. In a case of selecting the case-type housing, a pair of electric wires is connected to the pair of terminals, and then the case-type housing is assembled to the base member so as to engage with the engaging portion of the base member and so as to accommodate the terminals in the pair of accommodation chambers and insert the pair of electric wires inside and outside the pair of accommodation chambers.

### CROSS-REFERENCE TO RELATED APPLICATIONS

This application is based on and claims priority under 35 USC 119 from Japanese Patent Application No. 2024-168704 filed on Sep. 27, 2024, the contents of which are incorporated herein by reference.

### TECHNICAL FIELD

The present invention relates to a method for producing an electronic component unit including a base member that incorporates an electronic component and a housing integrally molded with the base member, and an electronic component unit.

### BACKGROUND ART

In the related art, an electronic component unit that incorporates an electronic component, for example, a temperature sensor that incorporates a temperature measuring element such as a thermistor, has been proposed (see, for example, Patent Literature 1).

### CITATION LIST

### Patent Literature

Patent Literature 1: JP2000-105151A

### SUMMARY OF INVENTION

### Technical Problem

When the electronic component unit of the above type is actually mounted on an automobile or the like, an electronic component unit having a structure with a strong waterproof treatment and an electronic component unit having a structure with a simple waterproof structure may be separately used depending on a place where the electronic component unit is to be mounted, according to a possibility of being exposed to water. It is required to produce an electronic component unit corresponding to such a plurality of specifications while reducing a production cost as much as possible without impairing the original performance of the electronic component unit.

An object of the present invention is to provide a method for producing an electronic component unit capable of producing an electronic component unit corresponding to a plurality of specifications at a low cost, and an electronic component unit.

### Solution to Problem

In order to achieve the above object, a method for producing an electronic component unit and an electronic component unit according to the present invention are characterized as follows.

A method for producing an electronic component unit that incorporates an electronic component is provided. The electronic component unit includes a base member including the electronic component, a pair of terminals connected to the electronic component and extending in a predetermined direction, and an accommodation body configured to accommodate the electronic component by embedding the electronic component therein, to expose each of the pair of terminals to an outside, and having, on an outer face, an engaging portion that protrudes or is recessed in a direction intersecting the predetermined direction, and a housing attached to the base member and configured to house the pair of terminals in a manner separated from each other. The method includes a first step of producing the base member; and a second step of selecting, as the housing, one of a connector-type housing that is integrally and additionally molded with the base member and that has a connector shape with a fitting opening for exposing one ends of the pair of terminals, and a case-type housing that is assembled to engage with the base member and that has a case shape with a pair of accommodation chambers for accommodating the pair of terminals in a manner separated from each other, and assembling the selected housing to the base member. In the second step, in a case of selecting the connector-type housing, the connector-type housing is integrally and additionally molded with the base member so as to fill the engaging portion of the accommodation body of the base member and so as to expose the one end to the fitting opening, and in a case of selecting the case-type housing, a pair of electric wires is connected to the pair of terminals, and then the case-type housing is assembled to the base member so as to engage with the engaging portion of the accommodation body of the base member and so as to accommodate the pair of terminals in the pair of accommodation chambers and insert the pair of electric wires inside and outside the pair of accommodation chambers.

An electronic component unit includes a base member that includes an electronic component, a pair of terminals connected to the electronic component and extending in a predetermined direction, and an accommodation body configured to accommodate the electronic component by embedding the electronic component therein, to expose each of the pair of terminals to an outside, and having, on an outer face, an engaging portion that protrudes or is recessed in a direction intersecting the predetermined direction; and a housing that fills the engaging portion of the accommodation body of the base member, that has a fitting opening for exposing one ends of the pair of terminals, and that is integrally molded with the base member.

### Advantageous Effects of Invention

With the method for producing an electronic component unit according to the present invention, the base member can be used as a common component both in the case of selecting the connector-type housing and in the case of selecting the case-type housing. In the case of selecting the connector-type housing, when the connector-type housing is integrally and additionally molded with the base member so as to fill the engaging portion of the accommodation body of the base member, the pair of terminals of the base member can be appropriately insulated from each other, and the connector-type housing and the base member can be firmly integrated with each other. Accordingly, for example, even in the case where an external force for fixing one of the base member and the connector-type housing and rotating the other is applied to the connector-type housing, the connector-type housing and the base member can be prevented from being separated from each other. On the other hand, in the case of selecting the case-type housing, when the case-type housing is assembled to the base member so as to engage with the engaging portion of the accommodation body of the base member, and the pair of terminals is accommodated in the pair of accommodation chambers, the pair of terminals of the base member can be appropriately insulated from each other, and the case-type housing can be held by the base member with sufficient strength. Accordingly, for example, similar to the above, the case-type housing and the base member can be prevented from being separated from each other. Therefore, with the method for producing an electronic component unit according to the present invention, the base member is used as a common component, and the housing is changed according to specifications, so that an electronic component unit corresponding to a plurality of specifications can be produced at a low cost.

Further, with the electronic component unit (electronic component unit using the connector-type housing) according to the present invention, when the housing is integrally molded with the base member so as to fill the engaging portion of the accommodation body of the base member, the pair of terminals of the base member can be appropriately insulated from each other, and the housing and the base member can be firmly integrated with each other. Accordingly, for example, even in the case where an external force for fixing one of the base member and the housing and rotating the other is applied to the housing, the housing and the base member can be prevented from being separated from each other. Therefore, the electronic component unit according to the present invention has excellent durability.

The present invention has been briefly described above. Further, details of the present invention will be clarified by reading modes for carrying out the invention described below with reference to the accompanying drawings.

### BRIEF DESCRIPTION OF DRAWINGS

FIG. 1 is a perspective view showing a base member used for assembling an electronic component unit according to an embodiment of the present invention.

FIG. 2 is a side view of the base member shown in FIG. 1.

FIG. 3 is a cross-sectional view taken along a line A-A in FIG. 2.

FIG. 4 is a perspective view showing a state where a treatment of bending an exposed portion of a terminal into an L shape has been performed on the base member shown in FIG. 1 in order to prepare for assembling a connector-type housing.

FIG. 5 is a perspective view showing an electronic component unit obtained by integrally and additionally molding a connector-type housing with the base member shown in FIG. 4.

FIG. 6 is a cross-sectional view taken along a line B-B in FIG. 5.

FIG. 7 is a cross-sectional view showing a periphery of a groove portion in the base member located between a pair of terminals in a cross section along a line C-C in FIG. 6.

FIG. 8 is a perspective view showing a state where a treatment of cutting an upper portion of the exposed portion of the terminal and connecting a lead wire to the remaining exposed portion has been performed on the base member shown in FIG. 1 in order to prepare for assembling a case-type housing.

FIG. 9 is a perspective view showing the base member shown in FIG. 8, and a case and a cover constituting the case-type housing to be assembled to the base member shown in FIG. 8.

FIG. 10 is a perspective view showing an electronic component unit obtained by assembling the case-type housing to the base member shown in FIG. 8.

FIG. 11 is a cross-sectional view taken along a line D-D in FIG. 10.

FIG. 12 is a cross-sectional view showing a periphery of a groove portion in the base member located between the pair of terminals in a cross section along a line E-E in FIG. 11.

### DESCRIPTION OF EMBODIMENTS

### Embodiments

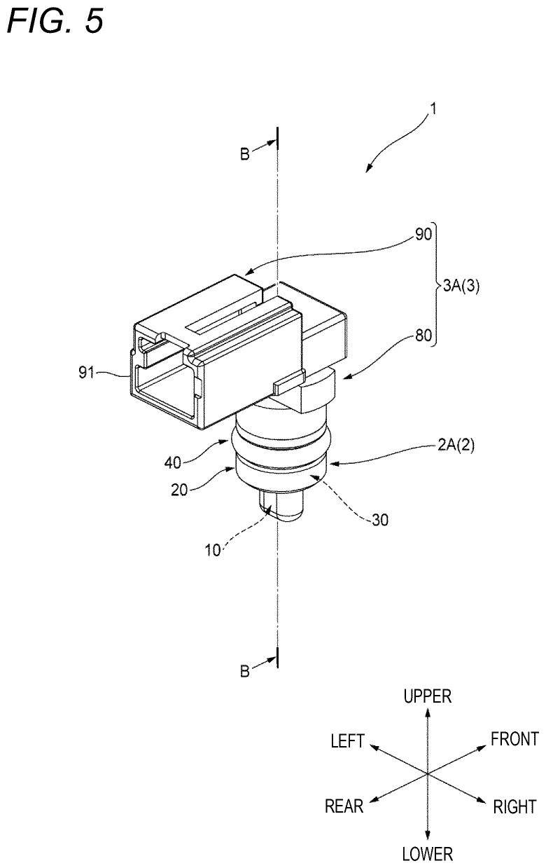

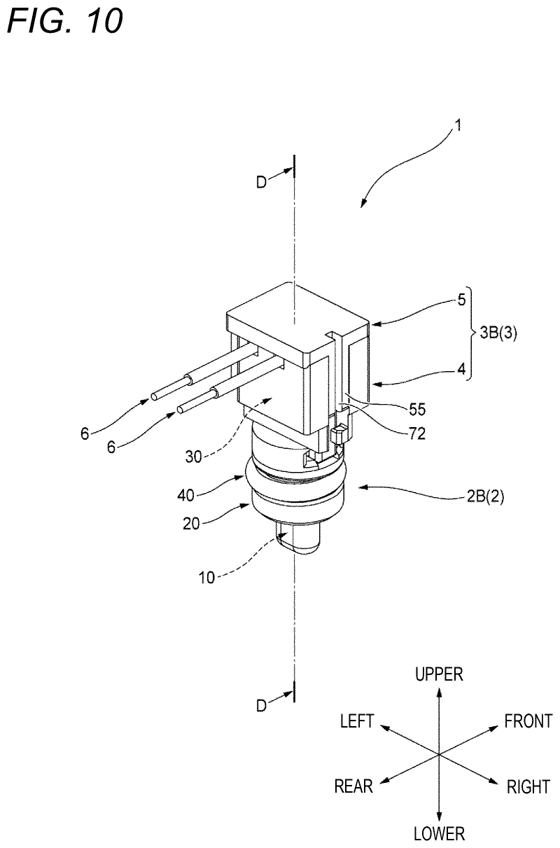

Hereinafter, an electronic component unit 1 and a method for producing the electronic component unit 1 according to an embodiment of the present invention will be described with reference to the drawings. The electronic component unit 1 (see FIG. 5 or 10) according to the embodiment of the present invention is used as a temperature sensor, for example, in a state where a base member 2 to be described later is inserted into and fixed to an attachment hole (not shown) in an attachment target. The attachment target is, for example, a wall of a container in which transmission oil, engine oil, or the like for a vehicle is stored, and in this case, the electronic component unit 1 attached to the attachment target functions to measure the temperature of the oil in the container.

As shown in FIG. 5 or 10, the electronic component unit 1 includes the base member 2 and a housing 3 assembled to the base member 2. As the housing 3, one of a connector-type housing 3A shown in FIG. 5 and a case-type housing 3B shown in FIG. 10 is selected and assembled to the base member 2. That is, both in the case of selecting the connector-type housing 3A as the housing 3 and in the case of selecting the case-type housing 3B as the housing 3, the electronic component unit 1 is formed using the base member 2 as a common component.

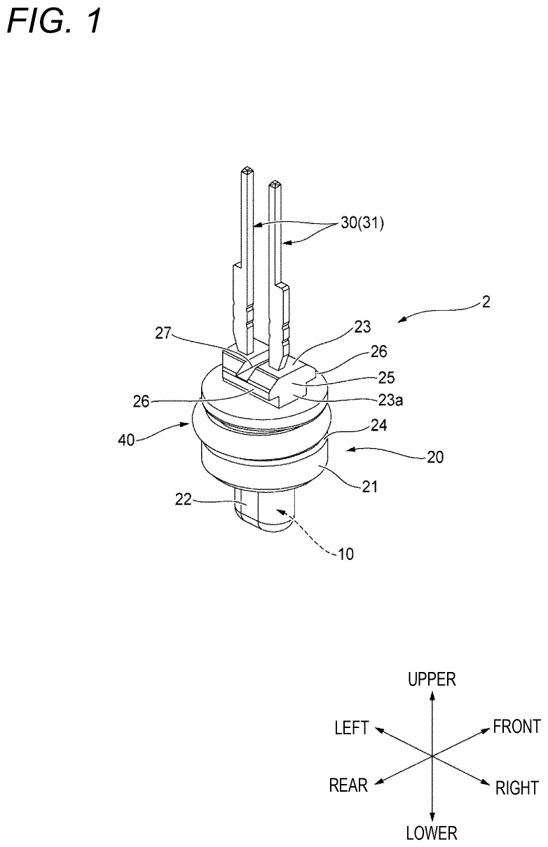

Hereinafter, for convenience of description, “front”, “rear”, “left”, “right”, “up”, and “down” are defined as shown in FIG. 1. A “front-rear direction”, a “left-right direction”, and an “up-down direction” are orthogonal to one another. The up-down direction corresponds to a “predetermined direction” according to the present invention. The front-rear direction, the left-right direction, and the up-down direction do not necessarily match the front-rear direction, the left-right direction, and the up-down direction of a vehicle or the like on which the electronic component unit 1 is to be mounted.

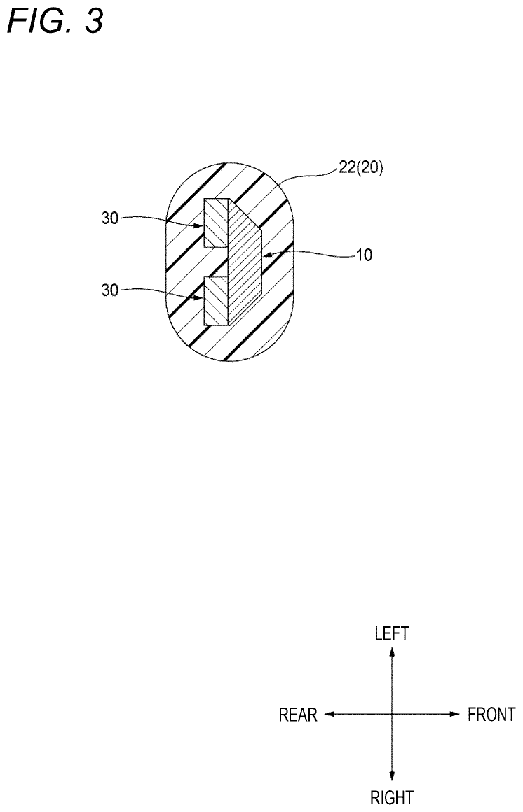

First, a configuration of the base member 2 used as a common component will be described. As shown in FIGS. 1 to 3, the base member 2 includes an electronic component 10 (see FIG. 3), an accommodation body 20 for accommodating the electronic component 10 by embedding the electronic component 10 therein, and a pair of terminals 30 connected to the electronic component 10 and exposed to the outside of the accommodation body 20. Specifically, the electronic component 10 is a thermistor element. The electronic component 10 and the pair of terminals 30 are integrated with the accommodation body 20 made of a resin by transfer molding or the like so as to be stored (embedded) inside the accommodation body 20.

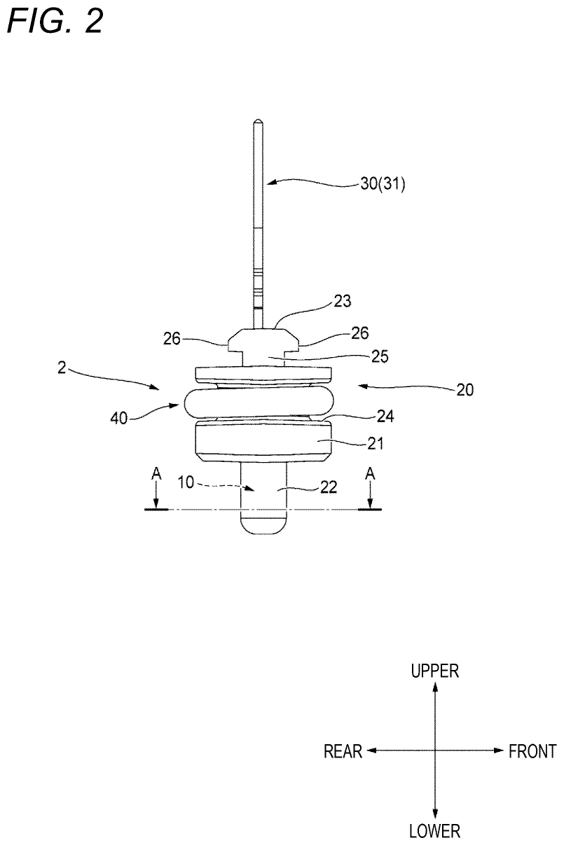

As shown in FIGS. 1, 2, and the like, the accommodation body 20, which is a resin molded body, integrally includes a columnar body portion 21 extending in the up-down direction, a protruding portion 22 protruding downward from a lower face of the body portion 21, and a projection portion 23 projecting upward from an upper face of the body portion 21. An annular groove 24 is formed in an outer peripheral face of the body portion 21, and a rubber O-ring 40 is mounted in the annular groove 24. The O-ring 40 mounted in the annular groove 24 is brought into close contact with an inner peripheral wall of the attachment hole of the attachment target to exhibit a waterproof function. As can be understood from FIG. 3, the protruding portion 22 has an elongated hole shape elongated in the left-right direction and protrudes downward from the body portion 21, and the entire electronic component 10 is embedded in the protruding portion 22. As shown in FIGS. 1, 2, and the like, the projection portion 23 includes a first portion 25 projecting upward from the upper face of the body portion 21 and extending in the left-right direction, and a pair of second portions 26 projecting from the entire region in the left-right direction on an upper end portion of the first portion 25 toward both sides in the front-rear direction, and has a substantially T shape when viewed in the left-right direction. A groove portion 27 penetrating the front-rear direction is formed in a central portion of an upper face of the projection portion 23 in the left-right direction. Here, the projection portion 23 corresponds to an “engaging portion” in the present invention, and the groove portion 27 corresponds to a “recess portion” in the present invention.

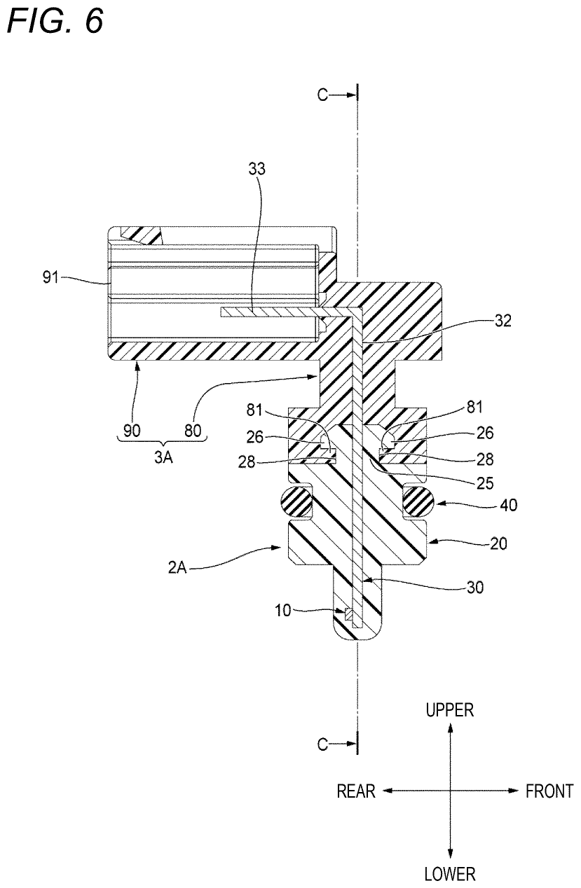

As can be understood from FIGS. 1, 2, 6, and the like, the pair of terminals 30 each have a shape extending substantially linearly in the up-down direction and are arranged side by side at an interval in the left-right direction, and the entire portion extending in the up-down direction and located below the exposed portion 31, that is an upper region, is embedded over the projection portion 23, the body portion 21, and the protruding portion 22 of the accommodation body 20. Lower end portions of the pair of terminals 30 located in the protruding portion 22 are connected to the electronic component 10 (see FIGS. 3 and 6). The exposed portions 31 of the pair of terminals 30 protrude to linearly extend upward from positions on both left and right sides of the groove portion 27 in an upper end face of the projection portion 23, and are exposed to the outside of the accommodation body 20. The configuration of the base member 2 used as a common component has been described above.

Next, a procedure of producing the electronic component unit 1 in the case of selecting the connector-type housing 3A (see FIG. 5) as the housing 3 to be assembled to the base member 2 used as a common component will be described.

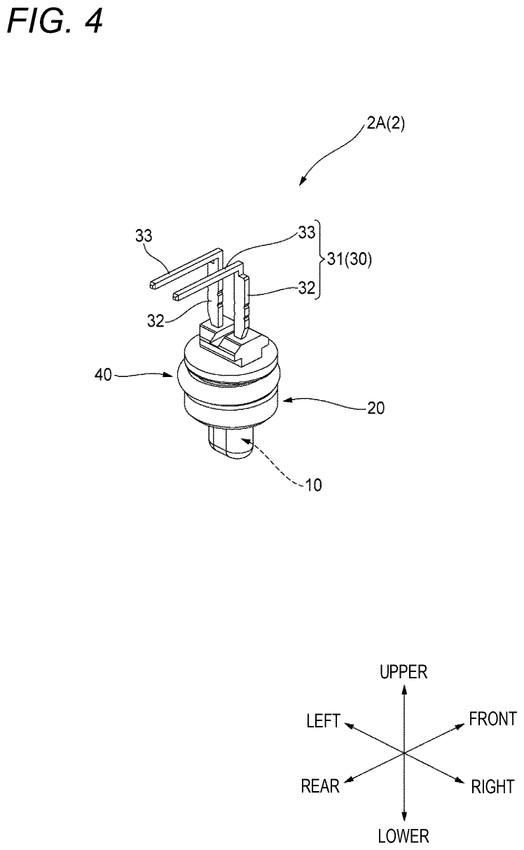

First, the base member 2 shown in FIG. 1 used as a common component is produced and prepared. Next, as shown in FIG. 4, a treatment of bending the exposed portion 31 of each of the pair of terminals 30 into an L shape is performed on the base member 2 shown in FIG. 1 in order to prepare for assembling the connector-type housing 3A. With this treatment, each of the exposed portions 31 of the pair of terminals 30 arranged at an interval in the left-right direction includes a first portion 32 linearly extending upward from the accommodation body 20 and a second portion 33 linearly extending rearward from an upper end portion of the first portion 32. Hereinafter, for convenience of description, the base member 2 shown in FIG. 4 is referred to as a “base member 2A”.

Next, as shown in FIGS. 5 and 6, the connector-type housing 3A made of a resin is additionally and integrally molded with the base member 2A. Specifically, the base member 2A is integrated with the connector-type housing 3A by insert molding or the like. The connector-type housing 3A additionally and integrally molded with the base member 2A integrally includes a body portion 80 integrated with the base member 2A and having a shape extending upward from the base member 2A, and a connector portion 90 having a substantially rectangular box-shaped hood shape extending so as to protrude rearward from an upper portion of the body portion 80. A rear end of the connector portion 90 is open and forms a fitting opening 91.

As shown in FIG. 6, the entire first portions 32 of the pair of terminals 30 of the base member 2A are embedded in the body portion 80. The second portions 33 of the pair of terminals 30 protrude rearward from a back wall (front end wall) of the connector portion 90 in a hollow portion of the hook-shaped connector portion 90. The second portions 33 of the pair of terminals 30 located in the hollow portion of the connector portion 90 are exposed to the outside through the fitting opening 91 of the connector portion 90.

As shown in FIG. 6, the body portion 80 integrated with the base member 2A is formed so as to fill an uneven structure formed by an outer shape of the entire projection portion 23 of the base member 2A. Specifically, a portion 81 of the body portion 80 enters, without a gap, a pair of front and rear groove portions 28 (recessed portions recessed inward in the front-rear direction and extending in the left-right direction) configured to be adjacent to lower sides of the pair of front and rear second portions 26 of the projection portion 23. Accordingly, the body portion 80 (that is, the connector-type housing 3A) and the base member 2A can be firmly integrated with each other. For example, even in the case where the base member 2A is fixed and a stress in a rotation direction with the up-down direction in which the pair of terminals 30 extends as a rotation axis is applied to the connector-type housing 3A, the connector-type housing 3A and the base member 2A can be prevented from being separated from each other. Further, the body portion 80 (that is, the connector-type housing 3A) is prevented from falling off upward from the base member 2A.

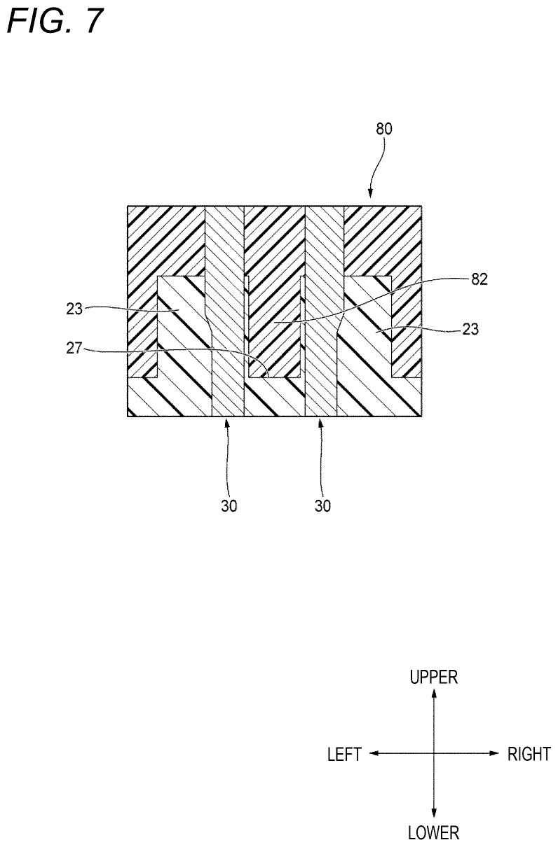

As shown in FIG. 7, the body portion 80 integrated with the base member 2A is molded so as to fill the groove portion 27 in the base member 2A (projection portion 23) located between the pair of terminals 30. Specifically, a portion 82 of the body portion 80 enters the groove portion 27 in the projection portion 23 without a gap. Accordingly, the pair of terminals 30 of the base member 2A can be appropriately insulated from each other, and a creepage distance between the pair of terminals 30 can be increased to further reliably insulate the pair of terminals 30 from each other. With the above, the assembly of the electronic component unit 1 is completed, and the electronic component unit 1 shown in FIG. 5 is obtained.

A counterpart connector (not shown) provided at an end portion of an electric wire extending from a temperature detection device (not shown) is fitted to the connector portion 90 of the electronic component unit 1 shown in FIG. 5 via the fitting opening 91. When the counterpart connector is connected to the connector portion 90, an electric signal (a signal indicating the temperature around the thermistor element) output from the electronic component 10 (thermistor element) is input to the temperature detection device, and the temperature around the thermistor element can be detected. The procedure of producing the electronic component unit 1 in the case of selecting the connector-type housing 3A has been described above.

Next, a procedure of producing the electronic component unit 1 in the case of selecting the case-type housing 3B (see FIG. 10) as the housing 3 to be assembled to the base member 2 used as a common component will be described.

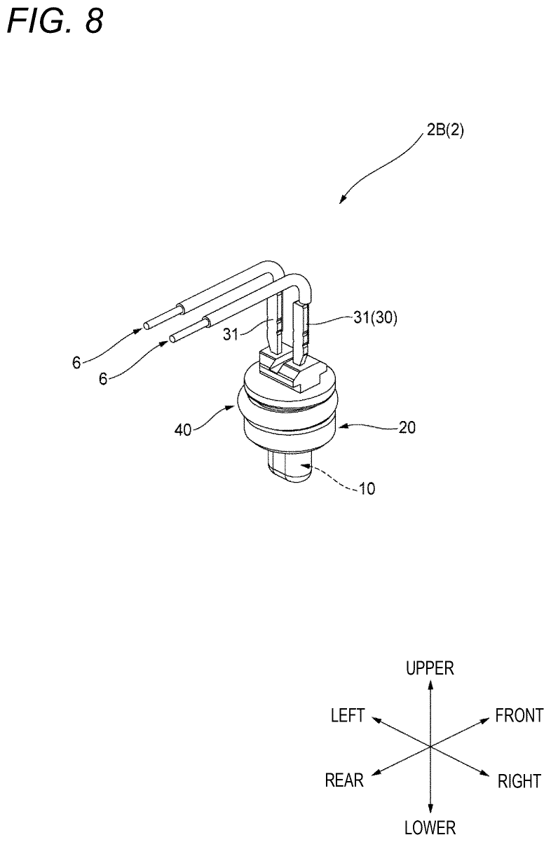

First, the base member 2 shown in FIG. 1 used as a common component is produced and prepared. Next, as shown in FIG. 8, a treatment of cutting an upper portion of each of the exposed portions 31 of the pair of terminals 30 and connecting one end portion of a lead wire 6 to each of the remaining exposed portions 31 is performed on the base member 2 shown in FIG. 1 in order to prepare for assembling the case-type housing 3B. Specifically, one end portion of each of the pair of lead wires 6 is connected to the exposed portion 31 of each of the pair of terminals 30 by welding. The pair of lead wires 6 extends upward from the exposed portions 31 of the pair of terminals 30. Each of the pair of lead wires 6 has flexibility so as to be freely bendable. Hereinafter, for convenience of description, the base member 2 shown in FIG. 8 is referred to as a “base member 2B”.

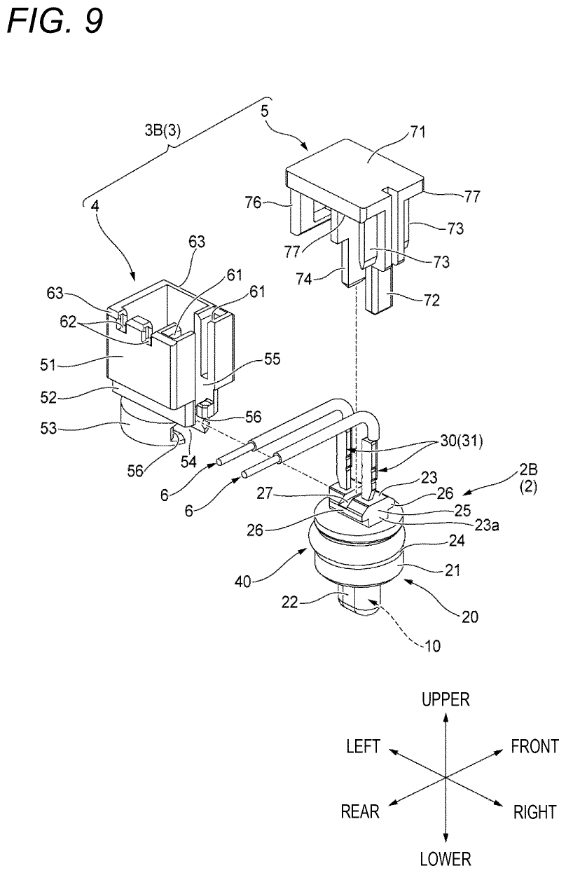

Next, a case 4 and a cover 5 (see FIG. 9) constituting the case-type housing 3B are produced and prepared. The case 4 and the cover 5 may be produced and prepared before the above “treatment of connecting the lead wire 6 to the exposed portion 31 of the terminal 30” is performed. Each of the case 4 and the cover 5 is produced by resin molding. The case 4 is a member to be assembled to the base member 2B, and the cover 5 is a member to be assembled to the case 4 in a state of being assembled to the base member 2B. Hereinafter, configurations of the case 4 and the cover 5 will be described in order.

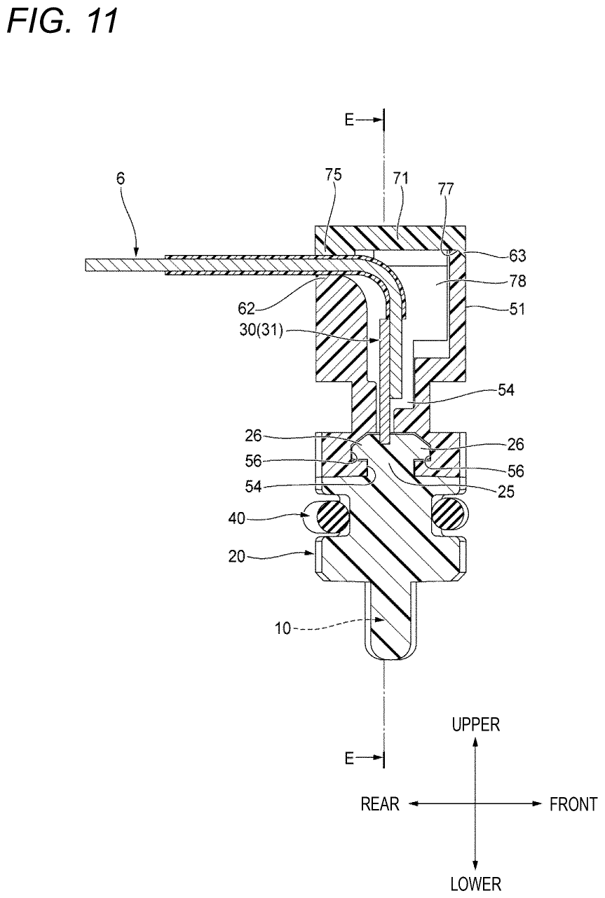

First, the configuration of the case 4 will be described. As shown in FIGS. 9 to 11, the case 4 integrally includes a substantially rectangular box-shaped body portion 51 having an open upper end, an elongated portion 52 protruding downward from a central portion of a bottom wall of the body portion 51 in the front-rear direction and extending in the left-right direction, and a columnar portion 53 continuous with a lower portion of the elongated portion 52 and extending in the up-down direction. An outer diameter of the columnar portion 53 is substantially equal to an outer diameter of the body portion 21 of the base member 2B (see FIGS. 10 and 11).

In the case 4, a slit portion 54 extending in the left-right direction from a right end to a vicinity portion of a left end of the elongated portion 52 and the columnar portion 53 is formed over the entire region in the up-down direction at a central portion of the elongated portion 52 and the columnar portion 53 in the front-rear direction (see FIGS. 9 and 11). The slit portion 54 opens rightward at the right end of the elongated portion 52 and the columnar portion 53, opens upward at an upper face of the elongated portion 52 (that is, a bottom face of the body portion 51), and opens downward at a lower face of the columnar portion 53. Further, in the case 4, a slit portion 55 extending in the up-down direction over the body portion 51 and the elongated portion 52 is formed at a central portion of a substantially rectangular flat plate-shaped right side wall of the body portion 51 and a right end portion of the elongated portion 52 in the front-rear direction (see FIGS. 9 and 10). The slit portion 55 opens in each of an upper face of the right side wall of the body portion 51, a lower face of the elongated portion 52, and inner and outer faces (left and right end faces) of the right side wall of the body portion 51. A lower end portion of the slit portion 55 overlaps a right end portion of the slit portion 54. Since the slit portion 54 and the slit portion 55 are formed in the case 4, the case 4 has a shape that is easily deformed to widen the slit portion 54 and the slit portion 55. When the case 4 is assembled to the base member 2B, the first portion 25 of the projection portion 23 of the base member 2B and the exposed portions 31 of the pair of terminals 30 are accommodated in the slit portion 54 (see FIG. 11), and the exposed portions 31 of the pair of terminals 30 and the pair of lead wires 6 pass through the slit portion 55 (see FIG. 11). When the cover 5 is assembled to the case 4, an extending portion 72 (to be described later) of the cover 5 is accommodated in the slit portion 55 (see FIG. 10)

A pair of front and rear groove portions 56 recessed outward in the front-rear direction and extending in the left-right direction is formed in inner walls on both front and rear sides of the slit portion 54 located in the columnar portion 53 corresponding to the pair of front and rear second portions 26 of the projection portion 23 of the base member 2B (see FIGS. 9 and 11). When the case 4 is assembled to the base member 2B, the pair of front and rear second portions 26 of the projection portion 23 of the base member 2B is accommodated in the pair of front and rear groove portions 56.

A pair of front and rear groove portions 61 recessed outward in the front-rear direction and extending in the up-down direction from an upper end of the right side wall to an intermediate position in the up-down direction is formed in inner walls on both front and rear sides of the slit portion 55 formed in the right side wall of the body portion 51 (see FIG. 9). When the cover 5 is assembled to the case 4, a pair of front and rear projection portions 73 (to be described later) of the cover 5 is accommodated in the pair of front and rear groove portions 61.

A pair of left and right recess portions 62 recessed downward is formed in an upper edge portion extending in the left-right direction at a substantially rectangular flat plate-shaped rear side wall of the body portion 51, corresponding to the pair of left and right lead wires 6 extending from the exposed portions 31 of the pair of left and right terminals 30. When the case 4 is assembled to the base member 2B, the pair of left and right lead wires 6 is inserted into the pair of left and right recess portions 62 (see FIGS. 10 and 11). A width (interval in the left-right direction) of each of the pair of left and right recess portions 62 is slightly smaller than the outer diameter of the lead wire 6. That is, the lead wire 6 is press-fitted into the recess portion 62.

An inclined face (flat face) 63 inclined outward in the front-rear direction is formed on an upper edge portion extending in the left-right direction at each of substantially rectangular flat plate-shaped front side wall and rear side wall of the body portion 51 (see FIGS. 9 and 11). When the cover 5 is assembled to the case 4, a pair of front and rear inclined faces 77 (to be described later) of the cover 5 is in face contact with the pair of front and rear inclined faces 63 (see FIGS. 9 and 11). A locking projection (not shown) is formed on an outer side face of a substantially rectangular flat plate-shaped left side wall of the body portion 51. When the cover 5 is assembled to the case 4, an edge of a locking hole of a locking frame portion 76 (to be described later, see FIG. 9) of the cover is engaged with the locking projection.

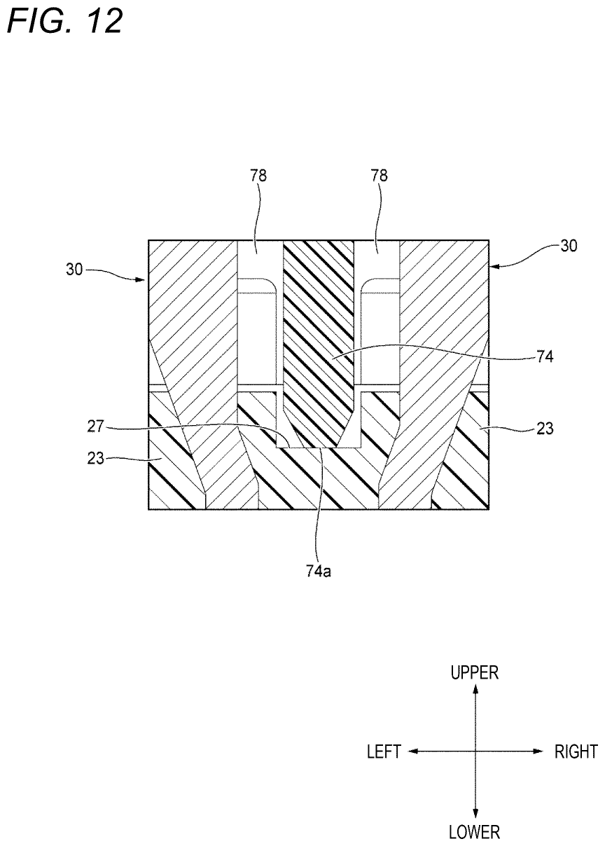

Next, the configuration of the cover 5 will be described. As shown in FIGS. 9 to 11, the cover 5 includes a top plate portion 71 having a rectangular flat plate shape corresponding to the shape of the upper end opening of the case 4 (body portion 51). At a central portion in the front-rear direction in a right end edge portion of the top plate portion 71 extending in the front-rear direction, the extending portion 72 having a substantially elongated flat plate shape is provided to extend downward corresponding to the slit portion 55 of the case 4. The pair of front and rear projection portions 73 projecting outward in the front-rear direction and extending in the up-down direction is provided on front and rear side faces of the extending portion 72. An extending portion 74 having a substantially elongated flat plate shape is provided on the top plate portion 71 at a central portion in the left-right direction and a central portion in the front-rear direction so as to extend downward. When the cover 5 is assembled to the case 4, a tip (lower end) 74a of the extending portion 74 enters the groove portion 27 of the projection portion 23 of the base member 2B and comes into contact with a bottom wall of the groove portion 27 (see FIG. 12). Here, the extending portion 74 corresponds to a “separation wall” in the present invention.

A pair of left and right projection portions 75 is formed at a rear end edge portion of the top plate portion 71 extending in the left-right direction so as to project downward corresponding to the pair of left and right recess portions 62 of the case 4 (see FIG. 11). The locking frame portion 76 having a locking hole is provided at a left end edge portion of the top plate portion 71 so as to extend downward corresponding to the locking projection of the case 4 (see FIG. 9). Each of a front end edge portion and a rear end edge portion of a lower face of the top plate portion 71 extending in the left-right direction is formed with the inclined face (flat face) 77 inclined inward in the front-rear direction corresponding to the pair of front and rear inclined faces 63 of the case 4 (see FIGS. 9 and 11). The configurations of the case 4 and the cover 5 have been described above.

Next, the case 4 is assembled to the base member 2B from a left side. Specifically, from a state where the case 4 is disposed on the left side of the base member 2B (see FIG. 9), the case 4 is assembled to the base member 2B such that the exposed portions 31 of the pair of terminals 30 and the pair of lead wires 6 pass through the slit portion 55, the first portion 25 of the projection portion 23 and the exposed portions 31 of the pair of terminals 30 are accommodated in the slit portion 54, and the pair of front and rear second portions 26 of the projection portions 23 is accommodated in the pair of front and rear groove portions 56 (see FIG. 11).

In a state where the assembly of the case 4 to the base member 2B is completed, the pair of front and rear second portions 26 of the projection portion 23 of the base member 2B and the pair of front and rear groove portions 56 of the case 4 are engaged with each other. That is, the pair of front and rear groove portions 56 of the case 4 is engaged with an uneven structure formed by an outer shape of the entire projection portion 23 of the base member 2B. Accordingly, the case 4 (that is, the case-type housing 3B) and the base member 2B can be firmly integrated with each other. For example, even in the case where the base member 2B is fixed and a stress in a rotation direction with the up-down direction in which the pair of terminals 30 extends as a rotation axis is applied to the case 4 (that is, the case-type housing 3B), the case 4 (that is, the case-type housing 3B) and the base member 2B can be prevented from being separated from each other. Further, the case 4 (that is, the case-type housing 3B) is prevented from falling off upward from the base member 2B. The slit portion 54 of the case 4 is closed by the first portion 25 of the projection portion 23 accommodated in the slit portion 54 (see FIG. 11). The exposed portions 31 of the pair of terminals 30 of the base member 2B are surrounded by a side wall portion of the body portion 51 of the case 4 (see FIG. 11). The pair of lead wires 6 extending upward from the exposed portions 31 of the pair of terminals 30 is bent rearward at root portions. One portion in an extending direction of the pair of lead wires 6 extending rearward in the front-rear direction from the bent portion is press-fitted into corresponding one of the pair of recess portions 62 of the case 4 (see FIGS. 10 and 11).

Next, the cover 5 is assembled to the case 4 from an upper side. Specifically, from a state where the cover 5 is disposed on the upper side of the case 4 (see FIG. 9), the cover 5 is assembled to the case 4 such that the top plate portion 71 closes the upper end opening of the body portion 51 and the extending portion 72 is accommodated in the slit portion 55 (see FIG. 10), such that the pair of front and rear projection portions 73 is accommodated in the pair of front and rear groove portions 61, such that the extending portion 74 enters between the exposed portions 31 of the pair of left and right terminals 30 and separates the pair of left and right exposed portions 31 in the left-right direction (see FIG. 12), such that the tip (lower end) 74a of the extending portion 74 enters the groove portion 27 of the projection portion 23 of the base member 2 and comes into contact with the bottom wall of the groove portion 27 (see FIG. 12), and such that the edge of the locking hole of the locking frame portion 76 is engaged with the locking projection.

In a state where the assembly of the case 4 to the cover 5 is completed, the top plate portion 71 closes the upper end opening of the body portion 51. When the edge of the locking hole of the locking frame portion 76 is engaged with the locking projection, the cover 5 is prevented from falling off upward from the case 4. A tip portion of the extending portion 72 is in contact with (engaged with) a right end face 23a (see FIG. 9) of the projection portion 23 of the base member 2B. Further, the pair of front and rear projection portions 73 is accommodated in the pair of front and rear groove portions 61. Accordingly, the cover 5 is prevented from falling off leftward from the case 4. The slit portion 55 of the case 4 is closed by the extending portion 72 accommodated in the slit portion 55. The extending portion 74 divides the hollow portion of the body portion 51 into two in the left-right direction, thereby defining a pair of left and right accommodation chambers 78 inside the body portion 51 (see FIGS. 11 and 12). Respective one of the exposed portions 31 of the pair of terminals 30 is accommodated in respective one of the pair of accommodation chambers 78. Accordingly, the exposed portions 31 of the pair of terminals 30 are accommodated in a manner separated from each other. The tip (lower end) 74a of the extending portion 74 is pressed against the bottom wall of the groove portion 27 of the projection portion 23 of the base member 2B and crushed (see FIG. 12). Accordingly, the pair of terminals 30 of the base member 2B can be appropriately insulated from each other, and a creepage distance between the pair of terminals 30 can be increased to further reliably insulate the pair of terminals 30 from each other. Each of the pair of lead wires 6 extending from the exposed portions 31 of the pair of terminals 30 extends rearward from each of the pair of accommodation chambers 78 to the outside of the electronic component unit 1 via the recess portion 62. The pair of left and right projection portions 75 of the cover 5 presses the lead wires 6 press-fitted into the pair of left and right recess portions 62 of the case 4 from the upper side (see FIG. 11). Accordingly, even when an external force is applied to the lead wire 6 extending from the electronic component unit 1 to the outside, the external force is prevented from being applied to a contact point between the lead wire 6 and the terminal 30 (exposed portion 31). The pair of front and rear inclined faces 77 of the cover 5 is in face contact with the pair of front and rear inclined faces 63 of the case 4, respectively. Accordingly, the deformation of the case 4 to widen the slit portion 54 and the slit portion 55 due to the engagement between the inclined face 77 and the inclined face 63 is prevented. With the above, the assembly of the electronic component unit 1 is completed, and the electronic component unit 1 shown in FIG. 10 is obtained.

The pair of lead wires 6 extending from the electronic component unit 1 (see FIG. 1) shown in FIG. 10 is electrically connected to electric wires extending from a temperature detection device (not shown). Accordingly, an electric signal (a signal indicating the temperature around the thermistor element) output from the electronic component 10 (thermistor element) is input to the temperature detection device, and the temperature around the thermistor element can be detected. The procedure of producing the electronic component unit 1 in the case of selecting the case-type housing 3B has been described above.

### <Operations and Effects>

As described above, with the method for producing the electronic component unit 1 according to the present embodiment, the base member 2 can be used as a common component both in the case of selecting the connector-type housing 3A and in the case of selecting the case-type housing 3B. In the case of selecting the connector-type housing 3A, when the connector-type housing 3A is integrally and additionally molded with the base member 2 so as to fill the engaging portion (projection portion 23) of the accommodation body 20 of the base member 2, the pair of terminals 30 of the base member 2 can be appropriately insulated from each other, and the connector-type housing 3A and the base member 2 can be firmly integrated with each other. For example, even in the case where the base member 2 is fixed and a stress in a rotation direction with a predetermined direction in which the pair of terminals 30 extends as a rotation axis is applied to the connector-type housing 3A, the connector-type housing 3A and the base member 2 can be prevented from being separated from each other. In the case of selecting the case-type housing 3B, when the case-type housing 3B is assembled to the base member 2 so as to engage with the engaging portion (projection portion 23) of the accommodation body 20 of the base member 2, and the pair of terminals 30 is accommodated in the pair of accommodation chambers 78, the pair of terminals 30 of the base member 2 can be appropriately insulated from each other, and the case-type housing 3B and the base member 2 can be firmly integrated with each other. For example, similar to the above, even in the case where a stress in the rotation direction is applied to the case-type housing 3B, the case-type housing 3B and the base member 2 can be prevented from being separated from each other. Therefore, with the method for producing the electronic component unit 1 according to the present embodiment, the electronic component unit 1 can be produced using a common component that can cope with a plurality of specifications.

Further, with the method for producing the electronic component unit 1 according to the present embodiment, when the recess portion (groove portion 27) in the accommodation body 20 of the base member 2 is filled with the connector-type housing 3A or when the separation wall (extending portion 74) of the case-type housing 3B is inserted into the recess portion (groove portion 27), the creepage distance between the pair of terminals 30 can be increased to further reliably insulate the pair of terminals 30 from each other.

Further, with the electronic component unit 1 (see FIG. 5) according to the present embodiment, when the housing 3 (connector-type housing 3A) is integrally molded with the base member 2 so as to fill the engaging portion (projection portion 23) of the accommodation body 20 of the base member 2, the pair of terminals 30 of the base member 2 can be appropriately insulated from each other, and the housing 3 and the base member 2 can be firmly integrated with each other. For example, even in the case where the base member 2 is fixed and the stress in the rotation direction with a predetermined direction in which the pair of terminals 30 extends as a rotation axis is applied to the housing 3, the housing 3 and the base member 2 can be prevented from being separated from each other. Therefore, with the electronic component unit 1 (see FIG. 5) according to the present embodiment, the electronic component unit can be produced using a common component that can cope with a plurality of specifications.

Further, with the electronic component unit 1 (see FIG. 5) according to the present embodiment, when the recess portion (groove portion 27) of the accommodation body 20 of the base member 2 is filled with the housing 3 (connector-type housing 3A), the creepage distance between the pair of terminals 30 can be increased to further reliably insulate the pair of terminals 30 from each other.

### Other Embodiments

The present invention is not limited to the above embodiment, and various modifications can be adopted within the scope of the present invention. For example, the present invention is not limited to the above embodiment, and modifications, improvements, and the like can be appropriately made. In addition, materials, shapes, sizes, numbers, arrangement positions, and the like of the components in the above embodiment are freely selected and are not limited as long as the present invention can be implemented.

For example, in the above embodiment, in the electronic component unit 1 (see FIG. 10) to which the case-type housing 3B is assembled, the contact point between the terminal 30 extending from the base member 2 and the lead wire 6 and the lead wire 6 extending from the terminal 30 are not embedded in a sealing body such as a potting resin inside the case 4 (body portion 51) (see FIG. 11). However, a hole (through hole) may be formed in the top plate portion 71 of the cover 5. By forming the hole, the potting material can be poured into the case 4 (body portion 51) through the hole and solidified. Accordingly, in the case 4 (body portion 51), when the contact point between the terminal 30 extending from the base member 2B and the lead wire 6 and the lead wire 6 extending from the terminal 30 are embedded in a sealing body such as a potting resin, it is possible to achieve further insulation between the terminals and between the contact points.

Here, features of the embodiment of the method for producing the electronic component unit 1 and the electronic component unit 1 according to the present invention described above will be briefly summarized and listed in the following [1] to [4].

[1] A method for producing an electronic component unit (1) that incorporates an electronic component (10), the electronic component unit (1) including
a base member (2) including the electronic component (10), a pair of terminals (30) connected to the electronic component (10) and extending in a predetermined direction, and an accommodation body (20) configured to accommodate the electronic component (10) by embedding the electronic component (10) therein, to expose each of the pair of terminals (30) to an outside, and having, on an outer face, an engaging portion (23) that protrudes or is recessed in a direction intersecting the predetermined direction, and
a housing (3) attached to the base member (2) and configured to house the pair of terminals (30) in a manner separated from each other,
the method including:
a first step of producing the base member (2); and
a second step of selecting, as the housing (3), one of a connector-type housing (3A) that is integrally and additionally molded with the base member (2) and that has a connector shape with a fitting opening (91) for exposing one ends of the pair of terminals (30), and a case-type housing (3B) that is assembled to engage with the base member (2) and that has a case shape with a pair of accommodation chambers (78) for accommodating the pair of terminals (30) in a manner separated from each other, and assembling the selected housing (3) to the base member (2), in which
in the second step,
   in a case of selecting the connector-type housing (3A), the connector-type housing (3A) is integrally and additionally molded with the base member (2) so as to fill the engaging portion (23) of the accommodation body (20) of the base member (2) and so as to expose the one end to the fitting opening (91), and
   in a case of selecting the case-type housing (3B), a pair of electric wires (6) is connected to the pair of terminals (30), and then the case-type housing (3B) is assembled to the base member (2) so as to engage with the engaging portion (23) of the accommodation body (20) of the base member (2) and so as to accommodate the pair of terminals (30) in the pair of accommodation chambers (78) and insert the pair of electric wires (6) inside and outside the pair of accommodation chambers (78).

With the method for producing an electronic component unit according to the above [1], the base member can be used as a common component both in the case of selecting the connector-type housing and in the case of selecting the case-type housing. In the case of selecting the connector-type housing, when the connector-type housing is integrally and additionally molded with the base member so as to fill the engaging portion of the accommodation body of the base member, the pair of terminals of the base member can be appropriately insulated from each other, and the connector-type housing and the base member can be firmly integrated with each other. Accordingly, for example, even in the case where an external force for fixing one of the base member and the connector-type housing and rotating the other is applied to the connector-type housing, the connector-type housing and the base member can be prevented from being separated from each other. On the other hand, in the case of selecting the case-type housing, when the case-type housing is assembled to the base member so as to engage with the engaging portion of the accommodation body of the base member, and the pair of terminals is accommodated in the pair of accommodation chambers, the pair of terminals of the base member can be appropriately insulated from each other, and the case-type housing can be held by the base member with sufficient strength. Accordingly, for example, similar to the above, the case-type housing and the base member can be prevented from being separated from each other. Therefore, with the method for producing an electronic component unit having this configuration, the base member is used as a common component, and the housing is changed according to specifications, so that an electronic component unit corresponding to a plurality of specifications can be produced at a low cost.

[2] In the method for producing an electronic component unit (1) according to the above [1], the base member (2) has a recess portion (27) in the outer face between the pair of terminals (30), the connector-type housing (3A) is molded so as to fill the recess portion (27), and the case-type housing (3B) has a separation wall (74) that is inserted into the recess portion (27) to separate the pair of accommodation chambers (78).

With the method for producing an electronic component unit according to the above [2], when the recess portion of the accommodation body of the base member is filled with the connector-type housing or when the separation wall of the case-type housing is inserted into the recess portion, a creepage distance between the pair of terminals can be increased to further reliably insulate the pair of terminals from each other.

[3] An electronic component unit (1) including: a base member (2) that includes an electronic component (10), a pair of terminals (30) connected to the electronic component (10) and extending in a predetermined direction, and an accommodation body (20) configured to accommodate the electronic component (10) by embedding the electronic component (10) therein, to expose each of the pair of terminals (30) to an outside, and having, on an outer face, an engaging portion (23) that protrudes or is recessed in a direction intersecting the predetermined direction; and a housing (3A) that fills the engaging portion (23) of the accommodation body (20) of the base member (2), that has a fitting opening (91) for exposing one ends of the pair of terminals (30), and that is integrally molded with the base member (2).

With the electronic component unit according to the above [3], when the housing is integrally molded with the base member so as to fill the engaging portion of the accommodation body of the base member, the pair of terminals of the base member can be appropriately insulated from each other, and the housing and the base member can be firmly integrated with each other. Accordingly, for example, even in the case where an external force for fixing one of the base member and the housing and rotating the other is applied to the housing, the housing and the base member can be prevented from being separated from each other. Therefore, the electronic component unit according to the present invention has excellent durability.

[4] In the electronic component unit (1) according to the above [3], the base member (2) has a recess portion (27) in the outer face between the pair of terminals (30), and the housing (3A) is molded so as to fill the recess portion (27).

With the electronic component unit according to the above [4], when the recess portion of the accommodation body of the base member is filled with the housing, a creepage distance between the pair of terminals can be increased to further reliably insulate the pair of terminals from each other.

What is claimed is:

1. A method for producing an electronic component unit that incorporates an electronic component, the electronic component unit including
a base member including the electronic component, a pair of terminals connected to the electronic component and extending in a predetermined direction, and an accommodation body configured to accommodate the electronic component by embedding the electronic component therein, to expose each of the pair of terminals to an outside, and having, on an outer face, an engaging portion that protrudes or is recessed in a direction intersecting the predetermined direction, and
a housing attached to the base member and configured to house the pair of terminals in a manner separated from each other,
the method comprising:
a first step of producing the base member; and
a second step of selecting, as the housing, one of a connector-type housing that is integrally and additionally molded with the base member and that has a connector shape with a fitting opening for exposing one ends of the pair of terminals, and a case-type housing that is assembled to engage with the base member and that has a case shape with a pair of accommodation chambers for accommodating the pair of terminals in a manner separated from each other, and assembling the selected housing to the base member, wherein
in the second step,
in a case of selecting the connector-type housing, the connector-type housing is integrally and additionally molded with the base member so as to fill the engaging portion of the accommodation body of the base member and so as to expose the one end to the fitting opening, and
in a case of selecting the case-type housing, a pair of electric wires is connected to the pair of terminals, and then the case-type housing is assembled to the base member so as to engage with the engaging portion of the accommodation body of the base member and so as to accommodate the pair of terminals in the pair of accommodation chambers and insert the pair of electric wires inside and outside the pair of accommodation chambers.

2. The method for producing an electronic component unit according to claim 1, wherein
the accommodation body of the base member has a recess portion in the outer face between the pair of terminals,
the connector-type housing is molded so as to fill the recess portion, and
the case-type housing has a separation wall that is inserted into the recess portion to separate the pair of accommodation chambers.

3. An electronic component unit comprising:
a base member that includes an electronic component, a pair of terminals connected to the electronic component and extending in a predetermined direction, and an accommodation body configured to accommodate the electronic component by embedding the electronic component therein, to expose each of the pair of terminals to an outside, and having, on an outer face, an engaging portion that protrudes or is recessed in a direction intersecting the predetermined direction; and
a housing that fills the engaging portion of the accommodation body of the base member, that has a fitting opening for exposing one ends of the pair of terminals, and that is integrally molded with the base member.

4. The electronic component unit according to claim 3, wherein
the base member has a recess portion in the outer face between the pair of terminals, and
the housing is molded so as to fill the recess portion.
